(19) United States
(12) Patent Application Publication
(10) Pub. No.: US 2019/0049725 A1
(43) Pub. Date: Feb. 14, 2019

(54) HEAD-UP DISPLAY DEVICE

(71) Applicant: MITSUBISHI ELECTRIC CORPORATION, Tokyo (JP)

(72) Inventors: Jun KONDO, Tokyo (JP); Shota NAKAHARA, Tokyo (JP); Atsushi MICHIMORI, Tokyo (JP)

(73) Assignee: MITSUBISHI ELECTRIC CORPORATION, Tokyo (JP)

(21) Appl. No.: 16/076,873

(22) PCT Filed: Mar. 29, 2017
(86) PCT No.: PCT/JP2017/012920

§ 371 Date: Aug. 9, 2018

(30) Foreign Application Priority Data
Mar. 30, 2016 (JP) 2016-066979

(51) Int. Cl. G02B 27/01; G09G 3/36; G02B 27/28

(52) U.S. Cl. CPC G02B 27/0101; G09G 3/36; G02B 27/283; G02B 2027/0127; G09G 2340/12; G09G 2380/10; G02B 27/286

(57) ABSTRACT

A head-up display device that superimposes a plurality of virtual images different in display distance (depth perception) on each other and display the superimposed virtual images is provided with a simple configuration. A head-up display device includes a synthetic optical system and a projection optical system. The synthetic optical system superimposes and emits first image light that travels through a first optical path and second image light that travels through a second optical path having an optical path length different from an optical path length of the first optical path. The projection optical system projects, as a virtual image, the first image light and the second image light superimposed and emitted by the synthetic optical system.

### TECHNICAL FIELD

The present invention relates to a head-up display device.

### BACKGROUND ART

There is a vehicle head-up display device using a liquid crystal display panel. The head-up display device displays information such as vehicle speed information or car navigation information in a driver's sight direction as a virtual image superimposed on a front view of the vehicle. Thus, a driver who is gazing at a sight in front of the vehicle can visually recognize information displayed as the virtual image with a small amount of eye movement. This virtual image is visually recognized by the driver as an image whose depth perception varies depending on a display distance at which the virtual image is displayed.

Patent Reference 1 describes a vehicle display device including a plurality of display units for displaying a plurality of display images with different depth perceptions, and, at a display-light emission portion of at least one of the display units, an optical filter for directing a direction of display light from the at least one of the display units to a direction different from that of display light from another one of the display units is provided.

### PRIOR ART REFERENCE

### Patent Reference

Patent Reference 1: Japanese Patent Application Publication No. H07-304352 (for example, paragraph 0012, paragraph 0013, and FIG. 1)

### SUMMARY OF THE INVENTION

### Problem to be Solved by the Invention

It is however difficult for the vehicle display device described in Patent Reference 1 to superimpose displays of the display units on one another. Moreover, the display device has a problem that information for attracting attention corresponding to a scene in the sight direction cannot be displayed to the driver.

The present invention has been made to solve the above problems in the prior art, and has an object of providing a head-up display device that can superimpose a plurality of virtual images different in display distance (depth perception) on each other and display the superimposed images with a simple configuration.

### Means of Solving the Problem

A head-up display device according to the present invention includes: a synthetic optical system to superimpose first image light that travels through a first optical path and second image light that travels through a second optical path having an optical path length different from an optical path length of the first optical path on each other, and emit the first image light and the second image light superimposed on each other; and a projection optical system to project, as a virtual image, the first image light and the second image light that are superimposed on each other and emitted by the synthetic optical system.

### Effects of the Invention

With the head-up display device according to the present invention, it is possible to obtain an advantage of superimposing a plurality of virtual images different in display distance (depth perception) on each other and displaying the superimposed virtual images, with a simple configuration.

### BRIEF DESCRIPTION OF THE DRAWINGS

FIG. 1 is a view illustrating a schematic configuration of a head-up display device according to an embodiment.

FIG. 2 is a plan view (a view seen in the direction of a projection optical system) illustrating a schematic configuration of a display area of a liquid crystal display panel in the embodiment.

FIG. 3 is an enlarged view illustrating a schematic configuration of a synthetic optical system in the embodiment.

FIG. 4 is a perspective view illustrating a schematic configuration of a polarization beam splitter in the embodiment.

FIG. 5 is a graph illustrating a relationship between an optical path length of image light that is a distance between a combiner and the liquid crystal display panel, and a display distance that is a distance between the combiner and a virtual image, in the embodiment.

FIG. 6 (a) is a side view illustrating display distances of a virtual image corresponding to a main area and virtual images corresponding to sub-areas in the embodiment, and FIG. 6 (b) is a top view illustrating the display distances of the virtual image corresponding to the main area and the virtual images corresponding to the sub-areas in the embodiment.

FIG. 7 is a plan view illustrating a schematic configuration of the virtual image corresponding to the main area and the virtual images corresponding to the sub-areas when seen from a driver in the embodiment.

FIG. 8 is a view illustrating a schematic configuration of a head-up display device according to a first variation.

FIG. 9 (a) is a side view illustrating display distances of a virtual image corresponding to a main area and virtual images corresponding to sub-areas in the first variation, and FIG. 9 (b) is a top view illustrating the display distances of the virtual image corresponding to the main area and the virtual images corresponding to the sub-areas in the first variation.

FIG. 10 is a view illustrating a schematic configuration of a head-up display device according to a second variation.

FIG. 11 (a) is a side view illustrating display distances of a virtual image corresponding to a main area and virtual images corresponding to sub-areas in the second variation, and FIG. 11 (b) is a top view illustrating the display distances of the virtual image corresponding to the main area and the virtual images corresponding to the sub-areas in the second variation.

FIG. 12 is a view illustrating a schematic configuration of a head-up display device according to a third variation.

FIG. 13 (a) is a side view illustrating display distances of a virtual image corresponding to a main area and a virtual image corresponding to a sub-area in the third variation, and FIG. 13 (b) is a top view illustrating the display distances of the virtual image corresponding to the main area and the virtual image corresponding to the sub-area in the third variation.

### MODE FOR CARRYING OUT THE INVENTION

Japanese Patent Application Publication No. 2009-015128, for example, describes a three-dimensional image display apparatus characterized by including a plurality of two-dimensional image forming devices, a focal distance adjustment optical element, an image combining optical element, and a display optical element (see, for example, paragraph 0016).

In the three-dimensional image display apparatus described in this patent reference, although two images different in display distance can be displayed, it is difficult to display three or more images different in display distance. In addition, a first polarization beam splitter for separation and a second polarization beam splitter for optical multiplexing are required, and an optical path becomes complicated. Furthermore, there is a problem that a size of the entire apparatus increases.

In the description of the following embodiment, XYZ coordinates will be used for facilitating description of the drawings. An X axis represents left and right directions with respect to the front of a vehicle on which a head-up display device 100 according to the present invention is mounted. A +X direction represents a leftward direction when the front of the vehicle is seen. A −X direction represents a rightward direction when the front of the vehicle is seen. A Y axis represents upward and downward directions. A +Y direction represents the upward direction. A −Y direction represents the downward direction. The upward direction is a direction toward the sky, and the downward direction is a direction toward the ground. A Z axis represents forward and rearward directions of the vehicle. A +Z direction represents the forward direction of the vehicle. A −Z direction represents the rearward direction of the vehicle. In the drawings, the same components are denoted by the same reference characters.

### (1) Embodiment

### (1-1) Configuration

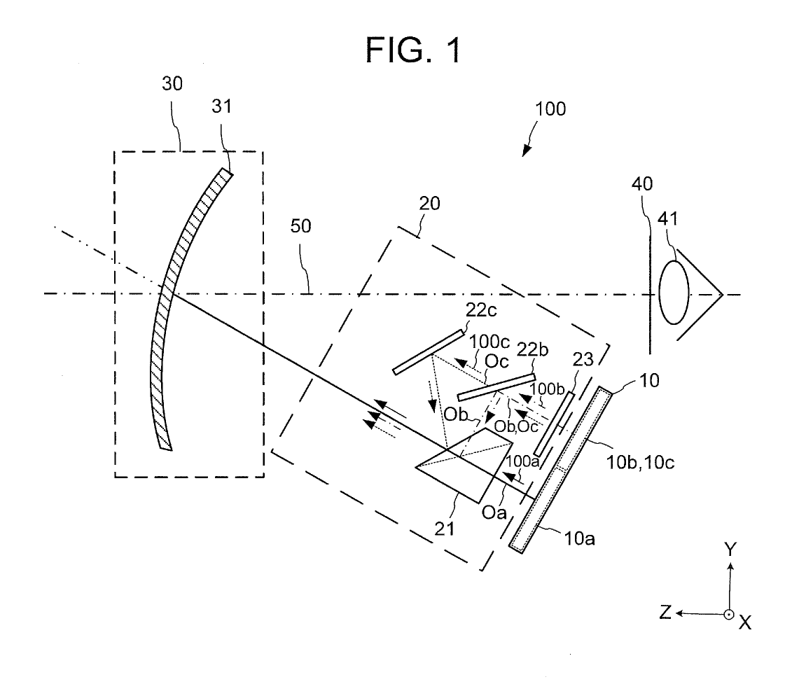

FIG. 1 is a view illustrating a schematic configuration of a head-up display device 100 according to an embodiment of the present invention. The head-up display device 100 according to the embodiment is, for example, configured to be mounted on a vehicle such as an automobile. As illustrated in FIG. 1, the head-up display device 100 according to the embodiment includes an image display element 10 as an image display device, a synthetic optical system 20, and a projection optical system 30. In the embodiment, the image display element 10 is described as a liquid crystal display panel, for example.

A range of the position of a driver's eye 41 necessary for a driver to visually recognize a virtual image is generally called an “eye box.” Also in this description, a range that allows the driver to visually recognize a virtual image is described as an “eye box 40.” The size of the eye box 40 is determined by a degree of diffusion of light emitted from the liquid crystal display panel 10. The size is determined also by design of the synthetic optical system 20. In FIG. 1, a straight line connecting the driver's eye 41 and the center of the projection optical system 30 is represented by an alternate long and short dash line 50.

The image display element is a display device for displaying information intended to be visually recognized by the driver. In the embodiment, the image display element will be described as the liquid crystal display panel 10, for example. It should be noted that the image display element is not limited to the liquid crystal display panel 10. The image display element 10 may also be another display device such as a projection display.

For example, the projection display is configured to scan a laser beam emitted from a laser light source and project an image on a screen. The screen maintains a polarization direction of the laser beam. For example, by using a microlens array for the screen, the polarization direction of the laser beam is maintained. The liquid crystal display panel and the projection display are examples of an image display module.

The liquid crystal display panel 10 receives light emitted from a backlight unit not illustrated in the drawings and generates image light. The “image light” means light including image information. That is, the image light is light modulated based on image information. The backlight unit is an illumination device that illuminates the liquid crystal display panel 10 from the back face thereof.

The liquid crystal display panel 10 is a general liquid crystal display panel. The general liquid crystal display panel is, for example, a TFT liquid crystal monitor employing an active matrix technology. There are some types of TFT liquid monitors, such as TN type, VA type and IPS type, for example.

The liquid crystal display panel 10 includes a polarizing filter for absorbing light polarized in one direction and a liquid crystal layer for rotating a polarization direction. Light emitted from the liquid crystal display panel 10 is polarized in the same direction. Thus, the liquid crystal display panel 10 is suitable for the image display element in this embodiment. As types of the liquid crystal display panel 10, there are a monochrome type provided with no color filters and a color type having RGB pixels. The liquid crystal display panel 10 according to the present invention is, however, not limited to these types.

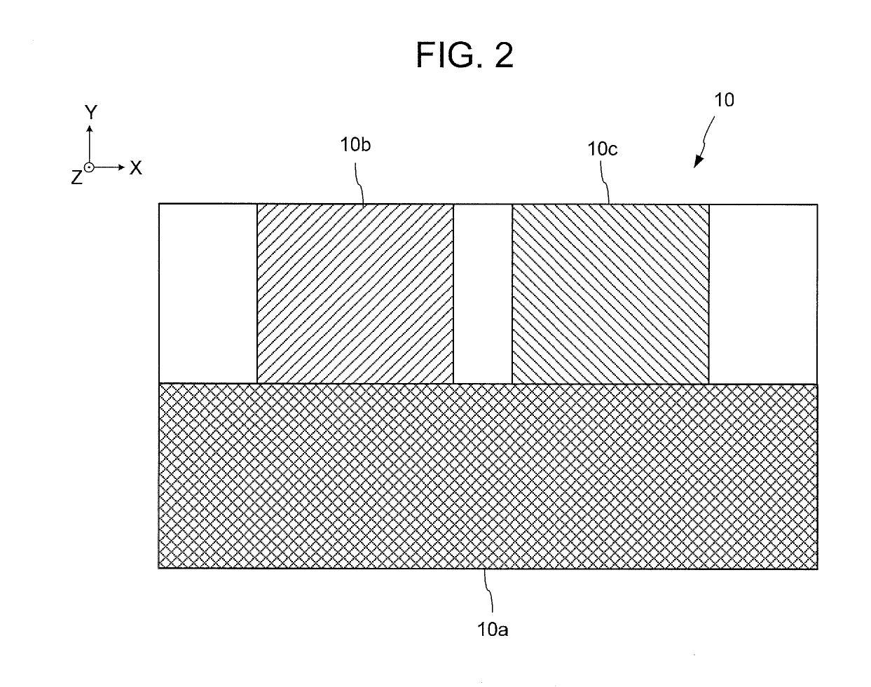

FIG. 2 is a view (a view seen in the direction of the projection optical system 30) illustrating a schematic configuration of a display area of the liquid crystal display panel 10 in the embodiment. FIG. 2 is a view of the liquid crystal display panel 10 seen from the +Z-axis direction side.

As illustrated in FIG. 2, in the embodiment, the display area of the liquid crystal display panel 10 is divided into three display areas, for example. The three display areas are a main area 10a, a sub-area 10b, and a sub-area 10c. The main area 10a is a first display area. The sub-area 10b is a second display area. The sub-area 10c is a third display area. The main area 10a and the sub-areas 10b and 10c are display regions of the liquid crystal display panel 10.

As illustrated in FIG. 2, the main area 10a occupies substantially a lower half of the display area of the liquid crystal display panel 10. The lower side is the −Y-axis direction side. As illustrated in FIG. 2, the sub-area 10b occupies a left area in an upper portion of the liquid crystal display panel 10. As illustrated in FIG. 2, the sub-area 10c occupies a right area of the upper portion of the liquid crystal display panel 10. The upper side is the +Y-axis direction side. In FIG. 2, the left side is the −X-axis direction side. In FIG. 2, the right side is the +X-axis direction side.

The main area 10a is used mainly for displaying information on the speed of the vehicle or the status of the vehicle, for example. The sub-areas 10b and 10c are, for example, used mainly for displaying information on attention attraction. The main area 10a and the sub-areas 10b and 10c are used for displaying virtual images different in display distance.

In this specification, the “display distance” means a distance between the position of the projection optical system 30 and a displayed virtual image. In other words, the “display distance” means the depth perception of a virtual image. The expression “different in display distance” means that a distance between the position of the projection optical system 30 and a displayed virtual image differs from a distance between the position of the projection optical system 30 and another displayed virtual image. In other words, the expression “different in display distance” means that depth perception of a displayed virtual image differs from that of another displayed virtual image when the driver sees the images. As the display distance increases, the virtual image is visually recognized as if the virtual image is displayed farther from the driver. As the display distance decreases, the virtual image is visually recognized as if the virtual image is displayed closer to the driver.

As illustrated in FIG. 2, the display area of the liquid crystal display panel 10 in the embodiment is the display area divided into three. However, it is not limited to this and it is sufficient to a display area divided into two or more. For example, the display area of the liquid crystal display panel 10 may be the main area 10a and the sub-area 10b only.

FIG. 2 shows that the main area 10a occupies substantially a half region of the liquid crystal display panel 10. However, the region of the main area 10a is not limited to this. The main area 10a may be divided into a plurality of display areas.

It is also shown that the main area 10a is adjacent to the sub-areas 10b and 10c. However, the present invention is not limited to this example. There may be a gap between the main area 10a and the sub-area 10b, 10c.

Moreover, the image light may be generated by combining a plurality of liquid crystal display panels. For example, the image light may be generated by combining one liquid crystal display panel including the main area 10a and other liquid crystal display panels including the sub-areas 10b and 10c.

As illustrated in FIG. 1, the projection optical system 30 includes a combiner 31. The combiner 31 is a reflection-type screen made of a translucent member. Since the combiner 31 is made of the translucent member, the driver can visually recognize a front scene through the combiner 31. That is, the driver can see the front scene from the position of the driver's eye 41 through the combiner 31.

A surface on the driver side of the combiner 31 has a predetermined reflectance at which light is reflected. That is, the combiner 31 has a reflection characteristic at the surface on the driver side. The projection optical system 30, which includes the combiner 31, can superimpose a projected virtual image on a scene in front of the driver.

As illustrated in FIG. 1, the reflection surface of the combiner 31 has a concave shape. This shape enables the combiner 31 to have a lens effect. The combiner 31 enlarges incident image light and projects the enlarged image light as a virtual image. Then, the combiner 31 enables the driver to visually recognize the image as if the image is floating at a position in front of the driver.

The combiner 31 is subjected to a surface treatment. With this surface treatment, a light transmittance and a light reflectance are adjusted so that a virtual image can be easily visually recognized. The present invention is not restricted by the presence or absence of this surface treatment or the manner of this surface treatment.

The embodiment describes a case that the combiner 31 is used for the projection optical system 30 is described. For the projection optical system 30 in the embodiment, however, a system except the projection optical system using the combiner 31 can be employed. For example, as the projection optical system 30, a projection optical system using a windshield of a vehicle, a concave mirror, a lens, or the like can be employed. The present invention is not limited to these types of projection optical systems. The present invention is applicable to, for example, a head-up display of a windshield projection type and a head-up display of a combiner projection type.

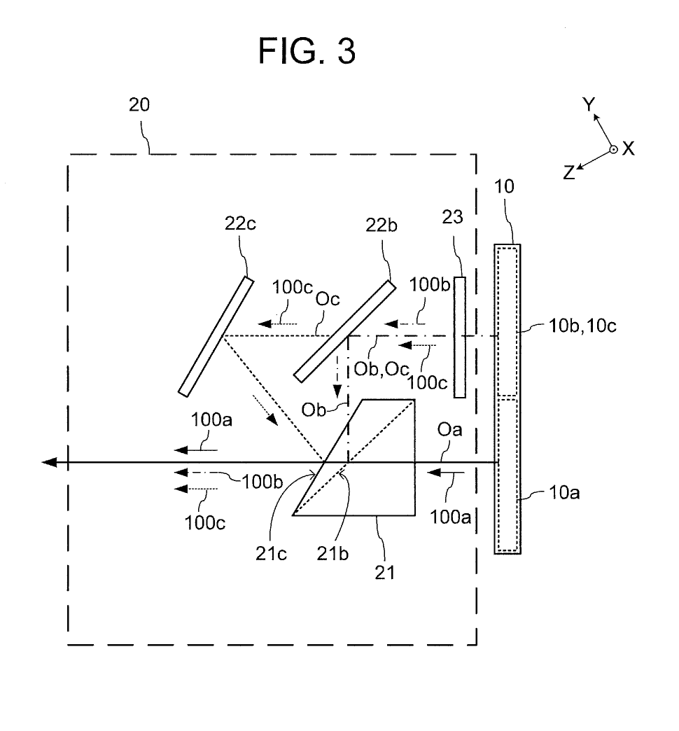

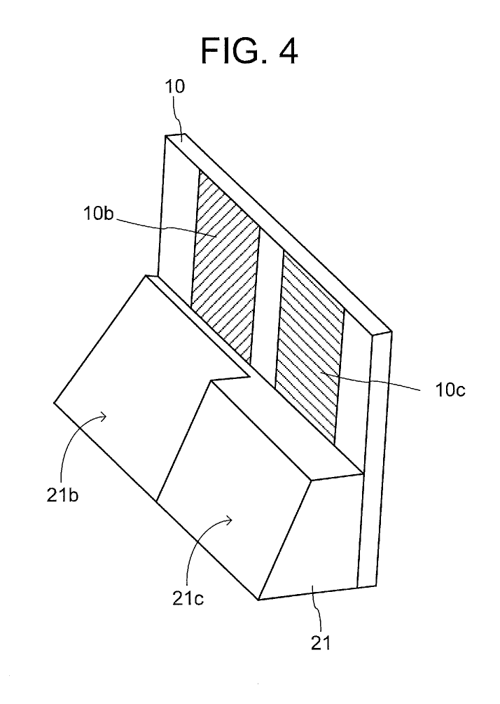

FIG. 3 is an enlarged view illustrating a schematic configuration of the synthetic optical system 20 in the embodiment. FIG. 4 is a perspective view illustrating a schematic configuration of the polarization beam splitter 21 in the embodiment.

As illustrated in FIG. 3, the synthetic optical system 20 in the embodiment includes the polarization beam splitter 21, reflection mirrors 22b and 22c, and a phase sheet 23.

As illustrated in FIGS. 3 and 4, the polarization beam splitter 21 is a prism-shaped member. The polarization beam splitter 21 includes a reflection surface 21b (first surface) and a reflection surface 21c (second surface). The reflection surface 21b reflects image light 100b. The reflection surface 21c reflects image light 100c. The reflection surfaces 21b and 21c transmit image light 100a. The reflection surfaces 21b and 21c are polarized light selection surfaces for selecting reflection or transmission of light according to a polarization direction of light. The reflection surface 21b is, for example, a first polarized light selection surface that reflects the image light 100b as second image light. The reflection surface 21c is, for example, a second polarized light selection surface that reflects the image light 100c as third image light. A region that transmits the image light 100a and regions that reflect the image light 100b and 100c may overlap each other.

The reflection surface 21b (first surface) and the reflection surface 21c (second surface) have different angles corresponding to incident angles of the image light 100b and 100c. The image light 100b and 100c is image light emitted from the sub-areas 10b and 10c of the liquid crystal display panel 10.

A tilt angle of the reflection surface 21b relative to an optical axis Oa of the image light 100a (first tilt angle) is different from a tilt angle of the reflection surface 21c relative to the optical axis Oa of the image light 100a (second tilt angle). Optical axes Ob and Oc (optical axes of center light beams) of the image light 100b and 100c reflected by the reflection surfaces 21b and 21c and the optical axis Oa (optical axis of the center light beam) of the image light 100a passing through the polarization beam splitter 21 are adjusted in such a manner that the optical axes Ob and Oc and the optical axis Oa overlap each other when seen in the X direction.

Here, regarding the optical axes, a light beam from the center point of an effective area of each of the display areas 10a, 10b, and 10c in FIG. 2 to the center point of the eye box 40 is referred to as an optical axis 0. That is, the optical axis here is the optical axis 0 of the projection optical system 30.

As illustrated in FIG. 4, in the embodiment, the shape of the polarization beam splitter 21 is a prism shape. However, the shape of the polarization beam splitter 21 is not limited to this. For example, the polarization beam splitter 21 may have a plate shape.

The polarization beam splitter 21 is used for the purpose of optically multiplexing the image light 100a, 100b, and 100c of different optical path lengths emitted from the different areas 10a, 10b, and 10c of the liquid crystal display panel 10.

The polarization beam splitter 21 has a characteristic of reflecting light or a characteristic of transmitting light according to a polarization direction of incident light. This characteristic can be obtained mainly by depositing a dielectric multilayer film, for example. However, a similar effect can also be obtained by bonding metal wire whose thickness is on the order of a wavelength which is called a wire grid. However, the polarization beam splitter 21 in the embodiment is not limited to these types.

Images are synthesized by polarization and thereby decrease of light utilization efficiency can be suppressed, as compared to a half mirror and so on, for example. Moreover, the use of the liquid crystal display panel 10 as a device for displaying an image makes it possible to easily obtain an image of polarized light.

As illustrated in FIG. 3, the synthetic optical system 20 includes the reflection mirror 22b and the reflection mirror 22c. The reflection mirror 22b is a first reflection mirror. The reflection mirror 22c is a second reflection mirror. The reflection mirrors 22b and 22c reflect the image light 100b and 100c while maintaining polarization directions of the image light 100b and 100c. The reflection mirrors 22b and 22c are examples of reflection elements. The reflection mirror 22b is a first reflection element that reflects the image light 100b. The reflection mirror 22c is a second reflection element that reflects the image light 100c.

As the reflection mirrors 22b and 22c, general mirrors on which metal for reflection, such as aluminum, is deposited can be used. The reflection mirrors 22b and 22c have smooth reflection surfaces, for example. For example, in a case where one image is reflected by arranging a plurality of prisms or the like it causes a division line generated when the image is divided by the prism to remain.

The reflection mirror 22b reflects the image light 100b emitted from the sub-area 10b of the liquid crystal display panel 10. The reflection mirror 22b guides the image light 100b to the reflection surface 21b of the polarization beam splitter 21. The reflection mirror 22c reflects the image light 100c emitted from the sub-area 10c of the liquid crystal display panel 10. The reflection mirror 22c guides the image light 100c to the reflection surface 21c of the polarization beam splitter 21.

As illustrated in FIG. 3, the reflection mirror 22b is disposed at a position closer to the liquid crystal display panel 10 in comparison with the reflection mirror 22c.

As illustrated in FIG. 3, the synthetic optical system 20 includes the phase sheet 23 on optical paths of the image light 100b and 100c emitted from the sub-areas 10b and 10c of the liquid crystal display panel 10. The phase sheet 23 has an effect of rotating the polarization directions of the image light 100b and 100c incident on the phase sheet 23 by 90 degrees about the optical axes Ob and Oc of the image light 100b and 100c. That is, the phase sheet 23 rotates the polarization direction of incident light by 90 degrees. The rotation direction may be clockwise or counterclockwise. The phase sheet 23 rotates the polarization direction of light and transmits the light. The phase sheet 23 is an example of a polarization rotation element.

By providing the phase sheet 23, the polarization direction of the image light 100a from the main area 10a and the polarization direction of the image light 100b and 100c from the sub-areas 10b and 10c are made orthogonal to each other.

The phase sheet 23 is that made of a resin or that made of a crystal. The phase sheet 23, however, is not limited to these materials.

In a case where the polarization direction of the image light 100b and 100c emitted from the sub-areas 10b and 10c of the liquid crystal display panel 10 is orthogonal to the polarization direction of the image light 100a emitted from the main area 10a beforehand, the synthetic optical system 20 does not need to include the phase sheet 23.

The solid line in FIG. 3 represents a trajectory of the image light 100a as first image light emitted from the main area 10a of the liquid crystal display panel 10. The solid arrows in FIG. 3 represent a traveling direction of the image light 100a. The “trajectory of the image light 100a” means a trajectory of the image light 100a after emission of the image light 100a from the liquid crystal display panel 10 to entry of the image light 100a in the combiner 31 (first optical path). The length of the trajectory of the image light 100a represents an optical path length of the image, light 100a.

As illustrated in FIG. 3, the image light 100a emitted from the main area 10a in a lower portion of the liquid crystal display panel 10 passes through the polarization beam splitter 21 and reaches the location of the combiner 31 in FIG. 1. The image light 100a emitted from the main area 10a of the liquid crystal display panel 10 passes through the polarization beam splitter 21. The image light 100a that has passed through the polarization beam splitter 21 reaches the combiner 31.

As illustrated in FIGS. 1 and 3, the optical path length of the image light 100a is shorter than the optical path lengths of the image light 100b and the image light 100c.

The alternate long and short dash line in FIG. 3 represents a trajectory of the image light 100b as the second image light emitted from the sub-area 10b of the liquid crystal display panel 10. The alternate long and short dash line arrows in FIG. 3 represent a traveling direction of the image light 100b. The “trajectory of the image light 100b” means a trajectory of the image light 100b after emission of the image light 100b from the liquid crystal display panel 10 to entry of the image light 100b in the combiner 31 (second optical path). The length of the trajectory of the image light 100b represents an optical path length of the image light 100b.

As illustrated in FIG. 3, the image light 100b emitted from the sub-area 10b of the liquid crystal display panel 10 is reflected by the reflection mirror 22b, reflected by the reflection surface 21b of the polarization beam splitter 21 and then reaches the position of the combiner 31 in FIG. 1. The image light 100b emitted from the sub-area 10b of the liquid crystal display panel 10 is reflected by the reflection mirror 22b. The image light 100b reflected by the reflection mirror 22b is reflected by the reflection surface 21b of the polarization beam splitter 21. The image light 100b refledted by the reflection surface 21b reaches the combiner 31.

As illustrated in FIGS. 1 and 3, the optical path length of the image light 100b is longer than the optical path length of the image light 100a. The optical path length of the image light 100b is shorter than the optical path length of the image light 100c.

The dotted lines in FIG. 3 represent a trajectory of the image light 100c as the third image light emitted from the sub-area 10c of the liquid crystal display panel 10. The dotted arrows in FIG. 3 represent a traveling direction of the image light 100c. The “trajectory of the image light 100c” means a trajectory of the image light 100c after emission of the image light 100c from the liquid crystal display panel 10 to entry of the image light 100c in the combiner 31 (third optical path). The length of the trajectory of the image light 100c represents an optical path length of the image light 100c.

As illustrated in FIG. 3, the image light 100c emitted from the sub-area 10c of the liquid crystal display panel 10 is reflected by the reflection mirror 22c and reflected by the reflection surface 21c of the polarization beam splitter 21 to reach the location of the combiner 31 in FIG. 1. The image light 100c emitted from the sub-area 10c of the liquid crystal display panel 10 is reflected by the reflection mirror 22c. The image light 100c reflected by the reflection mirror 22c is reflected by the reflection surface 21c of the polarization beam splitter 21. The image light 100c reflected by the reflection surface 21c reaches the combiner 31.

In FIG. 3, the image light 100c passes through an area on the front side (the +X axis side) of the reflection mirror 22b. That is, the image light 100c does not pass through the reflection mirror 22b.

As illustrated in FIGS. 1 and 3, the optical path length of the image light 100c is longer than the optical path lengths of the image light 100a and the image light 100b.

A principle in the embodiment of the present invention will be described below.

The head-up display device 100 according to the embodiment projects an image displayed on the liquid crystal display panel 10 as a virtual image in front of the driver with a lens effect by the combiner 31. At this time, the display distance is longer than a distance between the liquid crystal display panel 10 and the combiner 31. The display distance is a distance between the combiner 31 and the virtual image. Thus, the virtual image projected in front of the driver is larger than the image displayed on the liquid crystal display panel 10. In other words, with the combiner 31, the image displayed on the liquid crystal display panel 10 is projected while being enlarged as the virtual image.

The magnification and the display distance of this virtual image depend on a focal length of the combiner 31 and the distance from the liquid crystal display panel 10 to the combiner 31. That is, the magnification and the display distance of the virtual image depend on the optical path lengths of the image light 100a, 100b, and 100c.

In the head-up display device 100 according to the embodiment, the combiner 31 has a fixed shape. Accordingly, the focal length of the combiner 31 does not change. That is, the focal length of the combiner 31 is constant. Thus, the magnification and the display distance of the virtual image projected in front of the driver depend on the optical path lengths of the image light 100a, 100b, and 100c.

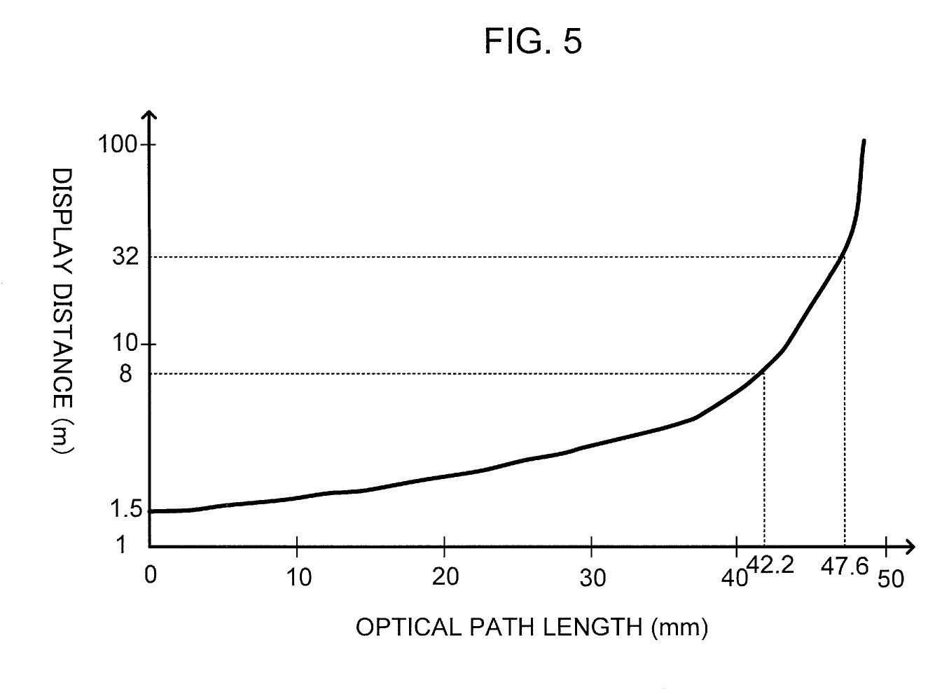

FIG. 5 is a graph showing a relationship between the optical path length of the image light and the display distance. The optical path length of image light is the distance from the liquid crystal display panel 10 to the combiner 31. That is, the optical path length of the image light is the distance between the combiner 31 and the liquid crystal display panel 10. The display distance is a distance from the combiner 31 to the virtual image.

A horizontal axis in FIG. 5 represents the optical path length of image light. That is, the abscissa represents the distance from the liquid crystal display panel 10 to the combiner 31. This optical path length is an optical path length with reference to an optical path length of image light having a display distance of 1.5 m (hereinafter referred to as a reference optical path length). The optical path length on the horizontal axis is represented by a difference from the reference optical path length. Thus, when the value of the horizontal axis is zero, the display distance is 1.5 m.

A vertical axis in FIG. 5 represents a display distance as a logarithm. The display distance is a distance from the combiner 31 to a projection location of the virtual image. That is, the display distance is the distance between the combiner 31 and the projection position of the virtual image.

For example, it is supposed that there is the following condition. A virtual image 60a corresponding to the main area 10a is displayed 1.5 m ahead of the combiner 31. An image corresponding to the sub-area 10b is displayed 8 m ahead of the combiner 31. An image corresponding to the sub-area 10c is displayed 32 m ahead of the combiner 31. In this condition, the distance between the optical path length of the image light 100c emitted from the sub-area 10c and the reference optical path length is set at 47.6 mm. The distance between the optical path length of the image light 100b emitted from the sub-area 10b and the reference optical path length is set at 42.2 mm. With these settings, the state of the above conditions can be achieved.

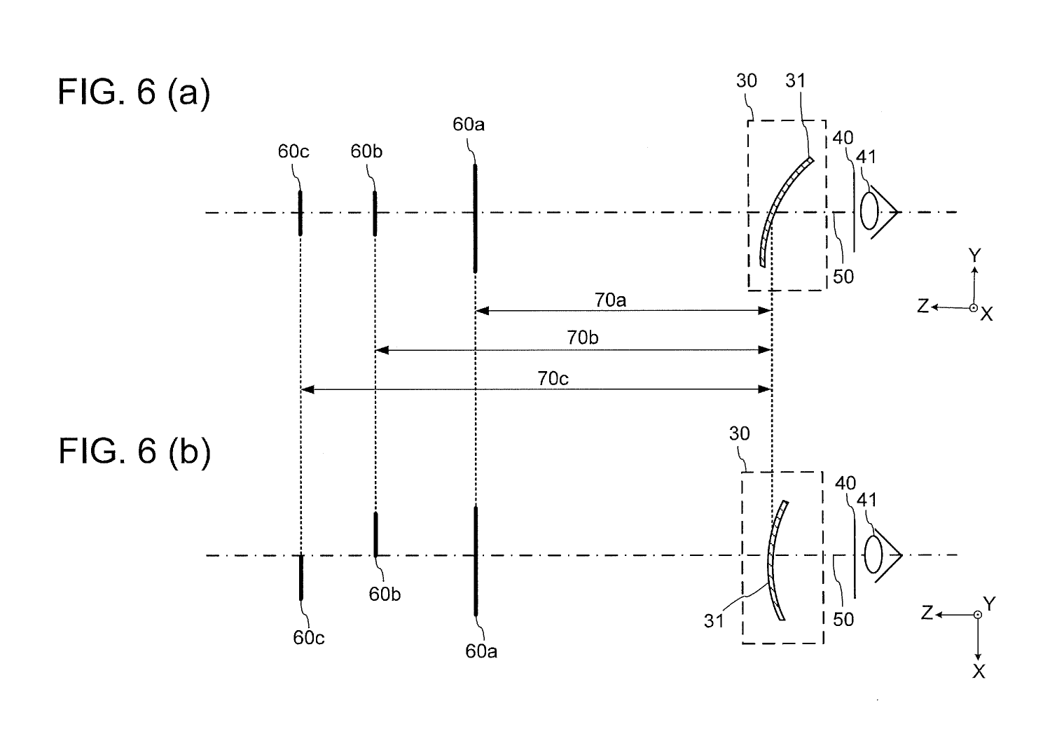

FIG. 6 (a) is a side view illustrating the display distances 70a, 70b, and 70c of the virtual image 60a corresponding to the main area 10a and the virtual images 60b and 60c corresponding to the sub-areas 10b and 10c. FIG. 6 (b) is a top view illustrating the display distances 70a, 70b, and 70c of the virtual image 60a corresponding to the main area 10a and the virtual images 60b and 60c corresponding to the sub-areas 10b and 10c.

As illustrated in FIGS. 6 (a) and 6 (b), among the three virtual images 60a, 60b, and 60c, the display distance 70c of the virtual image 60c corresponding to the sub-area 10c is the longest. The display distance 70b of the virtual image 60b corresponding to the sub-area 10b is the second longest, next to the display distance 70c of the virtual image 60c. The display distance 70a of the virtual image 60a corresponding to the main area 10a is the shortest.

As illustrated in FIG. 6 (a), in the side view, the virtual images 60b and 60c corresponding to the sub-areas 10b and 10c are located at the same position. That is, the positions where the virtual images 60b and 60c are displayed are at the same height.

As illustrated in FIG. 6 (b), in the top view, the virtual image 60b corresponding to the sub-area 10b is located at the −X-direction side (at the right side when seen from the driver's eye 41). The virtual image 60c corresponding to the sub-area 10c is located at the +X-direction side (at the left side when seen from the driver's eye 41).

As illustrated in FIGS. 6 (a) and 6 (b), when seen from the driver's eye 41, the virtual image 60a and the virtual image 60b are displayed to be superimposed on each other. The virtual image 60a and the virtual image 60c are displayed to be superimposed on each other.

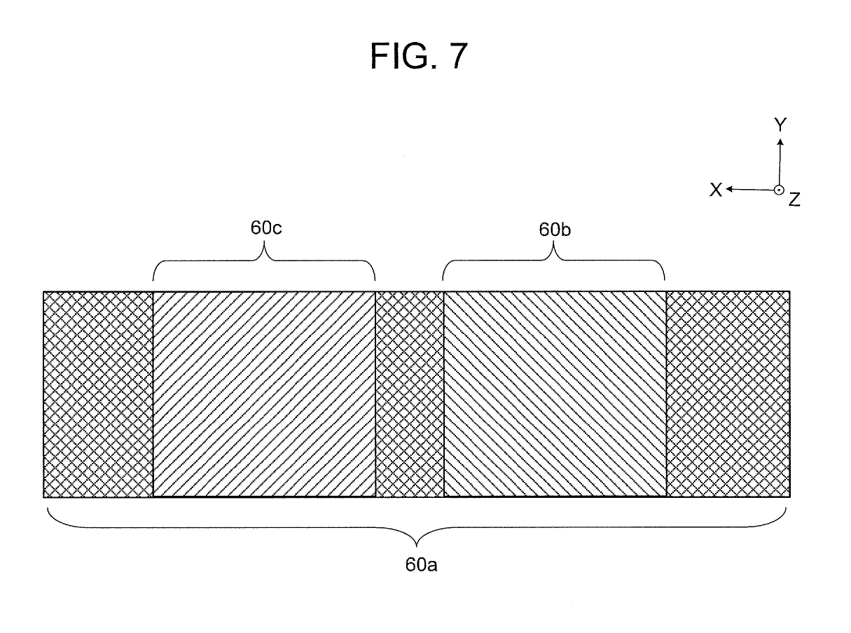

FIG. 7 is a view illustrating a schematic configuration of the virtual image 60a corresponding to the main area 10a and the virtual images 60b and 60c corresponding to the sub-areas 10b and 10c when the virtual images are seen from the driver. As illustrated in FIG. 7, the virtual image 60a and the virtual image 60b are displayed while being superimposed on each other. The virtual image 60a and the virtual image 60c are displayed while being superimposed on each other.

In the embodiment described above, the polarization beam splitter 21 is disposed on the optical path of the image light 100a from the main area 10a. The reflection mirrors 22b and 22c are disposed on the optical paths of the image light 100b and 100c from the sub-areas 10b and 10c. However, it is not limited to this. For example, a reflection mirror may be disposed on the optical path of the image light 100a from the main area 10a. The image light 100a is reflected by this reflection mirror. The image light 100a reflected by the reflection mirror is reflected by the reflection surface of the polarization beam splitter 21. On the other hand, the image light 100b and 100c from the sub-areas 10b and 10c passes through the polarization beam splitter. The synthetic optical system 20 may have such a configuration.

### (1-2) Effects

In the head-up display device 100 according to the embodiment, the image light 100a from the main area 10a, the image light 100b from the sub-area 10b, and the image light 100c from the sub-area 10c enter the combiner 31 with their optical path lengths being different from each other. Accordingly, the display distance 70a of the virtual image 60a displayed by the image light 100a, the display distance 70b of the virtual image 60b displayed by the image light 100b, and the display distance 70c of the virtual image 60c displayed by the image light 100c can be made display distances different from each other. The virtual image 60a and the virtual image 60b can be superimposed on each other. The virtual image 60a and the virtual image 60c can be superimposed on each other. In other words, the three virtual images with different depth perceptions can be superimposed on each other to be displayed to the driver.

### (2) First Variation

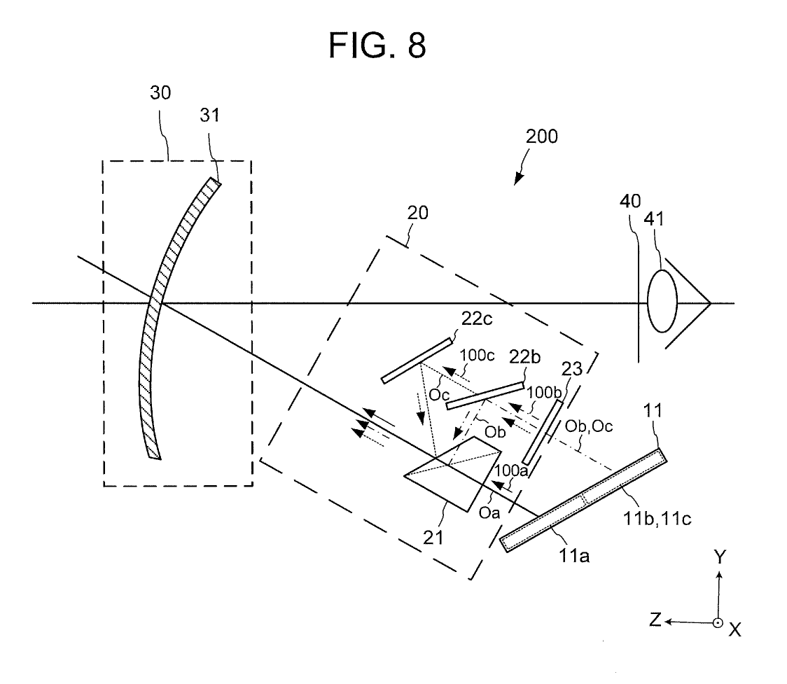

FIG. 8 is a view schematically illustrating a configuration of a head-up display device 200 according to a first variation of the present invention. In FIG. 8, components identical or corresponding to those illustrated in FIG. 1 (the embodiment) are assigned the same reference characters as those in FIG. 1. Description of those components will be omitted.

As illustrated in FIG. 8, the head-up display device 200 according to the first variation is different from the head-up display device 100 according to the embodiment in that a liquid crystal display panel 11 is disposed with a tilt relative to the optical axis Oa of the image light 100a.

The identical components are the synthetic optical system 20 and the projection optical system 30. Although the liquid crystal display panel 11 is assigned a reference character different from that of the liquid crystal display panel 10 in the embodiment, the liquid crystal display panels themselves have no difference. In the first variation, since the liquid crystal display panel is tilted, there is a case where a viewing angle is appropriately controlled. Description of a main area 11a and sub-areas 11b and 11c will be replaced by description of the embodiment.

In FIG. 8, the liquid crystal display panel 11 is tilted so as to be rotated clockwise relative to the liquid crystal display panel 10 illustrated in FIG. 1 when seen from the +X axis direction. Accordingly, for example, a virtual image 61a tilts in such a manner that the upper side (+Y-axis side) of the virtual image 61a is seen at a far side. Similarly, virtual images 61b and 61c tilt in such a manner that the upper sides (+Y-axis sides) of the virtual images 61b and 61c are seen at a far side. The tilt of the liquid crystal display panel 11 is adjusted by the tilts (tilt angles) of the reflection mirrors 22b and 22c and the tilts (tilt angles) of the reflection surfaces 21b and 21c.

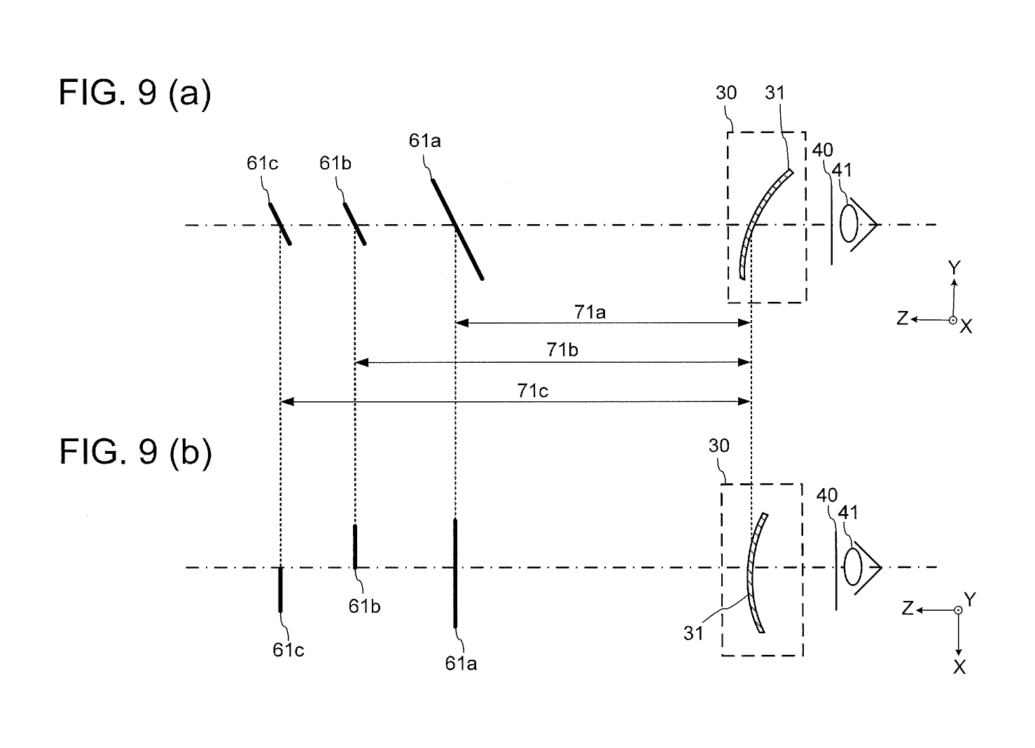

FIG. 9 (a) is a side view illustrating display distances 71a, 71b, and 71c of the virtual image 61a corresponding to the main area 11a and the virtual images 61b and 61c corresponding to the sub-areas 11b and 11c in the first variation. FIG. 9 (b) is a top view illustrating the display distances 71a, 71b, and 71c of the virtual image 61a corresponding to the main area 11a and the virtual images 61b and 61c corresponding to the sub-areas 11b and 11c in the first variation.

As illustrated in FIG. 9 (a), by tilting the liquid crystal display panel 11, the virtual image 61a corresponding to the main area 11a can be visually recognized by the driver while being tilted. Accordingly, the virtual image 61a can be displayed in three dimensions. In addition, information represented by the virtual image can be easily recognized by the driver. Similarly, the virtual images 61b and 61c corresponding to the sub-areas 11b and 11c can be tilted. Accordingly, the virtual images 61b and 61c can be displayed in three dimensions.

In the first variation described above, all the main area 11a and the sub-areas 11b and 11c are tilted. However, it is not limited to this. The sub-areas 11b and 11c may be arranged to be vertical to the driver's sight direction and a display image by adjusting the tilts (tilt angles) of the reflection mirrors 22b and 22c and the tilts (tilt angles) of the reflection surfaces 21b and 21c. Accordingly, only the main area 11a can be displayed as a tilted image. The sub-areas 11b and 11c can be displayed as vertical images.

### (3) Second Variation

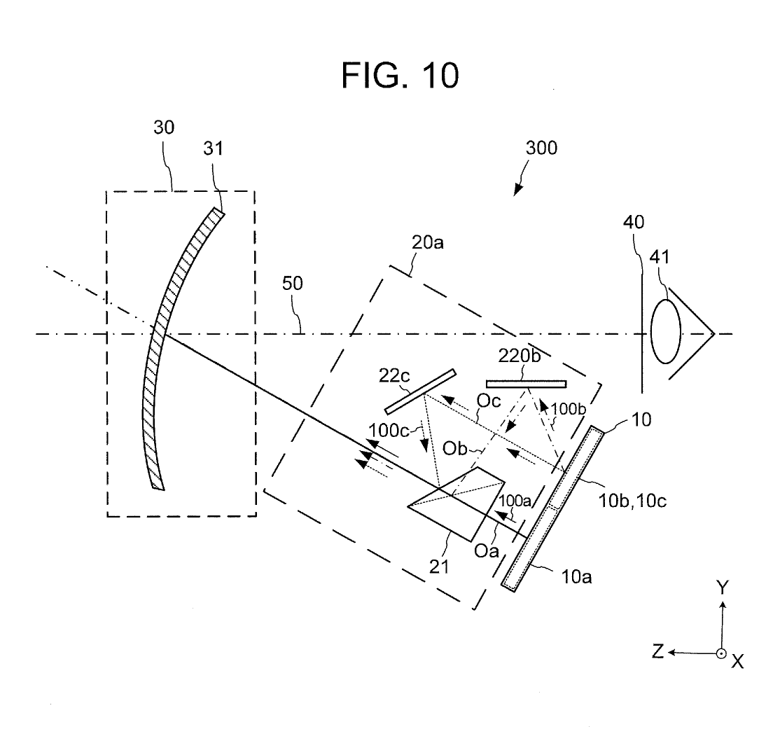

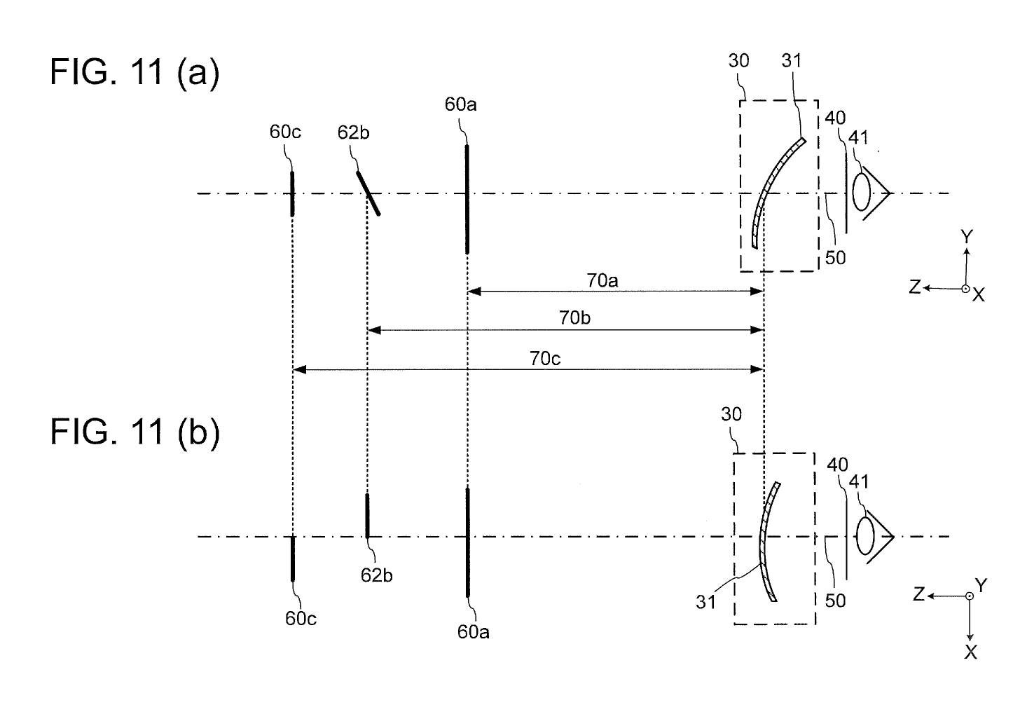

FIG. 10 is a configuration diagram schematically illustrating a configuration of a head-up display device 300 according to a second variation. FIG. 11 (a) is a side view illustrating the display distances 70a, 70b, and 70c of the virtual image 60a corresponding to the main area 10a and virtual images 62b and 60c corresponding to the sub-areas 10b and 10c in the second variation. FIG. 11 (b) is a top view illustrating the display distances 70a, 70b, and 70c of the virtual image 60a corresponding to the main area 10a and the virtual images 62b and 60c corresponding to the sub-areas 10b and 10c in the second variation.

As illustrated in FIG. 10, the head-up display device 300 according to the second variation is different from the head-up display device 100 according to the embodiment in a configuration of a synthetic optical system 20a. Specifically, the difference is that a reflection mirror 220b is disposed instead of the reflection mirror 22b. Regarding the other part, the configuration of the head-up display device 300 according to the second variation is the same as that of the head-up display device 100 according to the embodiment.

In the embodiment, the head-up display device 100 projects an image of the main area 10a and the sub-areas 10b and 10c seen from the front. That is, the head-up display device 100 displays, as a virtual image, an image of a view from a direction vertical to the display surface of the liquid crystal display panel 10.

In the first variation, the head-up display device 200 projects an image of the main area 11a and the sub-areas 11b and 11c seen obliquely. That is, the head-up display device 200 displays, as a virtual image, an image of a view from an oblique direction relative to the display surface of the liquid crystal display panel 11.

In contrast, in the second variation, the head-up display device 300 projects an image of the main area 10a and the sub-area 10c seen from the front, for example. On the other hand, the head-up display device 300 projects an image of the sub-area 10b seen obliquely, for example.

As illustrated in FIG. 10, the reflection mirror 220b is disposed at the +Y-axis side with respect to the optical axis Oc of the image light 100c emitted from the sub-area 10c. In addition, as illustrated in FIG. 10, when seen from the +X axis direction, the reflection mirror 220b according to the second variation is tilted so as to be rotated clockwise in comparison to the reflection mirror 22b according to the embodiment illustrated in FIG. 1.

As illustrated in FIG. 10, the image light 100b emitted from the sub-area 10b passes through an area on the +Y-axis side of the image light 100c emitted from the sub-area 10c and enters the reflection mirror 220b. The image light 100b reflected by the reflection mirror 220b then enters the polarization beam splitter 21. Accordingly, in the polarization beam splitter 21, an image displayed in the sub-area 10b is superimposed on an image displayed in the main area 10a.

As illustrated in FIG. 11 (a), the virtual image 60a corresponding to the main area 10a is seen from the driver as an image displayed vertically. The virtual image 60c corresponding to the sub-area 10c is seen from the driver as an image displayed vertically. On the other hand, the virtual image 62b corresponding to the sub-area 10b is seen from the driver as an image displayed with a tilt. As illustrated in FIGS. 11 (a) and 11 (b), the virtual image 60a of the liquid crystal display panel 10a is displayed at the position of the display distance 70a, and the virtual image 62b of the liquid crystal display panel 10b is displayed at the position of the display distance 70b, and the virtual image 60c of the liquid crystal display panel 10c is displayed at the position of the display distance 70c.

As described above, in the head-up display device 300 according to the second variation, the virtual image 62b corresponding to the sub-area 10b is seen with a tilt, and thereby the image displayed corresponding to the sub-area 10b can be displayed in three dimensions in conformity with a forward scene. The display can be made so that the driver can easily recognize information.

In the second variation, the virtual image 60a corresponding to the main area 10a is displayed as an image displayed vertically. The virtual image 60c corresponding to the sub-area 10c is displayed as an image displayed vertically. The virtual image 62b corresponding to the sub-area 10b is displayed as an image displayed with a tilt. However, this second example is merely an example, and is not intended to limit the present invention. The image displayed with a tilt can be determined in any manner.

### (4) Third Variation

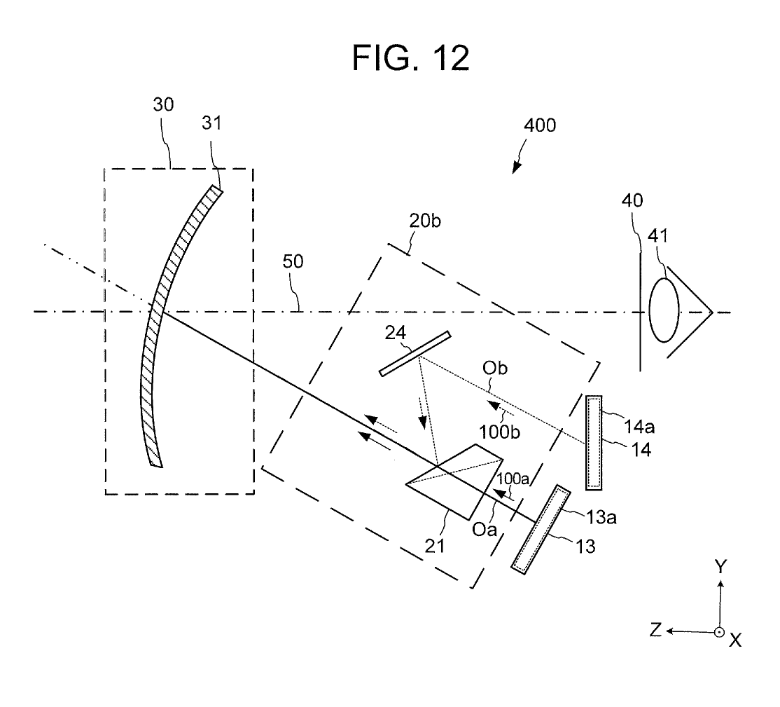

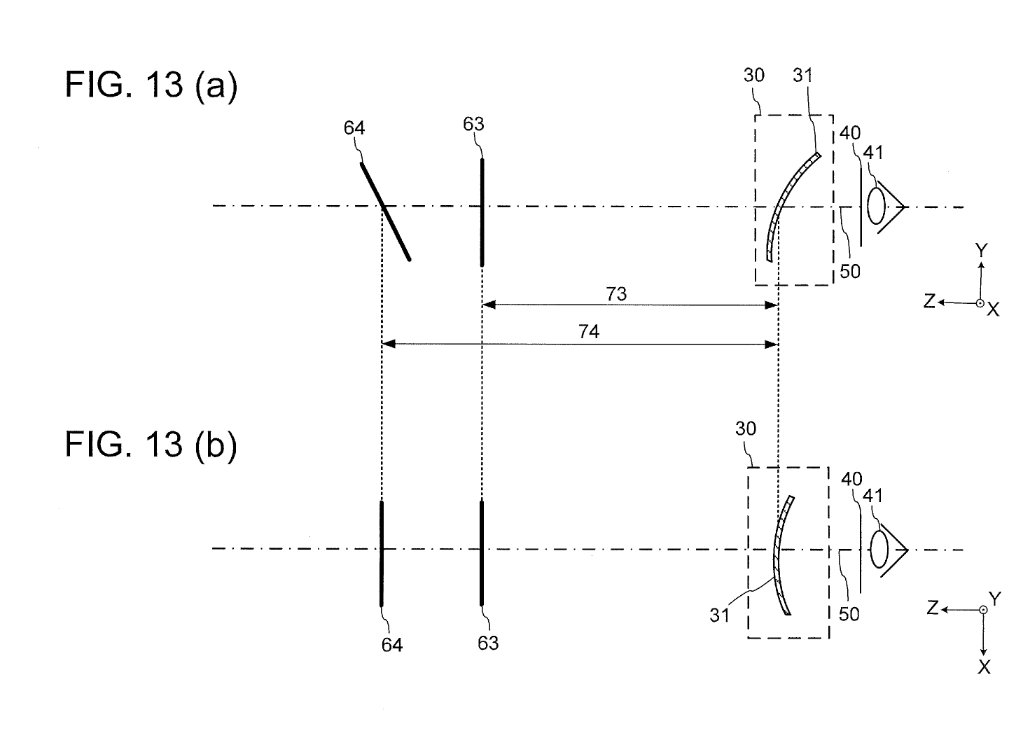

FIG. 12 is a configuration diagram schematically illustrating a configuration of a head-up display device 400 according to a third variation. FIG. 13 (a) is a side view illustrating display distances 73 and 74 of a virtual image 63 corresponding to a main area 13a and a virtual image 64 corresponding to a sub-area 14a in the third variation. FIG. 13 (b) is a top view illustrating the display distances 73 and 74 of the virtual image 63 corresponding to the main area 13a and the virtual image 64 corresponding to the sub-area 14a in the third variation.

As illustrated in FIG. 12, the head-up display device 400 according to the third variation is different from the head-up display device 100 according to the embodiment and the head-up display devices 200 and 300 according to the first and second variations in configurations of liquid crystal display panels 13 and 14 and a configuration of a synthetic optical system 20b. Regarding the other part, the configuration of the head-up display device 400 according to the third variation is the same as those of the head-up display device 100 according to the embodiment and the head-up display devices 200 and 300 according to the first and second variations.

In the embodiment and the first and second variations described above, the area of each of the liquid crystal display panels 10 and 11 is divided to display virtual images. On the other hand, the head-up display device 400 according to the third variation is different from those of the embodiment and the first and second variations described above in that the virtual images 63 and 64 are displayed not by dividing the area of a single liquid crystal display panel but by using the plurality of liquid crystal display panels 13 and 14. With the change in the configurations of the liquid crystal display panels 13 and 14, the synthetic optical system 20b also has a configuration different from those of the synthetic optical systems 20 and 20a.

As illustrated in FIG. 12, the head-up display device 400 according to the third variation includes, as image display devices, the liquid crystal display panel 13 and the liquid crystal display panel 14, for example.

In the first variation and the second variation described above, the display area of the single liquid crystal display panel 10 is divided into the main area 10a and the sub-areas 10b and 10c. On the other hand, in the third variation, by using the liquid crystal display panel 13, an image corresponding to the main area 13a is displayed. By using the liquid crystal display panel 14, an image corresponding to the sub-area 14a is displayed. Note that, by using the liquid crystal display panel 14, an image corresponding to another sub-area can also be displayed.

As illustrated in FIG. 12, the two liquid crystal display panels 13 and 14 are disposed at different installation angles. The liquid crystal display panel 13 is disposed vertically to the optical axis Oa. On the other hand, the liquid crystal display panel 14 is disposed with a tilt relative to the optical axis Ob.

Moreover, as illustrated in FIG. 12, the synthetic optical system 20b of the head-up display device 400 according to the third variation includes a reflection mirror 24. The reflection mirror 24 reflects image light 100b emitted from the sub-area 14a of the liquid crystal display panel 14 to guide the light to a reflection surface of the polarization beam splitter 21, and the light is superimposed on image light 100a.

Accordingly, as illustrated in FIG. 13 (a), the virtual image 63 of the liquid crystal display panel 13 is displayed vertically to the driver. On the other hand, the virtual image 64 of the liquid crystal display panel 14 is displayed with a tilt to the driver. As illustrated in FIGS. 13 (a) and 13 (b), the virtual image 63 of the liquid crystal display panel 13 is displayed at the position at the display distance 73, and the virtual image 64 of the liquid crystal display panel 14 is displayed at the position at the display distance 74.

Thus, the head-up display device 400 according to the third variation can display the virtual images 63 and 64 in three-dimensions in conformity with a forward scene. Accordingly, information can be displayed so as to be easily recognized by the driver.

In the foregoing embodiment described above, terms indicating positional relationships among components, such as “parallel” or “vertical,” or the shape of a component are sometimes used. These terms are intended to include a range in which tolerances in production and variations in assembly are taken into consideration. Thus, in description indicating a positional relationship among components or a shape of a component in the claims, this description includes a range in which a tolerance in production and/or variations in assembly are taken into consideration.

Although the foregoing description is directed to the embodiment of the present invention, the invention is not limited to the embodiment.

Based on the above embodiment, the content of the invention will be described below as appendix (1) and appendix (2). In appendix (1) and appendix (2), reference characters will be individually denoted. Thus, “appendix 1” is present in both appendix (1) and appendix (2). The following appendixes do not describe the entire invention.

Moreover, features of appendix (1) and features of appendix (2) may be combined.

### (Appendix (1))

### (Appendix 1)

A head-up display device including:

a first display area that generates first image light;

a second display area that generates second image light;

a synthetic optical system that includes a first optical path and a second optical path having different optical path lengths, that receives the first image light and the second image light, and that superimposes the first image light that travels by way of the first optical path and the second image light that travels by way of the second optical path on each other and emits the superimposed first image light and second image light; and

a projection optical system that projects, as a virtual image, the first image light and the second image light that are superimposed and emitted by the synthetic optical system.

### (Appendix 2)

The head-up display device described in appendix 1, wherein

the synthetic optical system includes:

a first reflection mirror that reflects the second image light, and

a polarization beam splitter, and

the polarization beam splitter includes a first surface that transmits the first image light, reflects the second image light reflected by the first reflection mirror, superimposes the first image light and the second image light, and emits the superimposed first and second image light.

### (Appendix 3)

The head-up display device described in appendix 2, wherein the entire second image light that travels by way of the second optical path is superimposed on the first image light that travels by way of the first optical path and is emitted.

### (Appendix 4)

The head-up display device described in appendix 3, wherein the first display area and the second display area are different display areas of one image display device.

### (Appendix 5)

The head-up display device described in appendix 4, further including a third display area that generates third image light, wherein

the synthetic optical system further includes a third optical path having a third optical path length different from the first optical path and the second optical path, superimposes the first image light that travels by way of the first optical path and the third image light that travels by way of the third optical path on each other, and emits the superimposed first and third image light.

### (Appendix 6)

The head-up display device described in appendix 5, wherein

the synthetic optical system further includes a second reflection mirror that reflects the third image light, and

the polarization beam splitter further includes a second surface that transmits the first image light, reflects the third image light reflected by the second reflection mirror, superimposes the first image light and the third image light on each other, and emits the superimposed first and third image light.

### (Appendix 7)

The head-up display device described in appendix 6, wherein a first tilt angle of the first surface with respect to an emission direction of the first image light is different from a second tilt angle of the second surface with respect to the emission direction of the first image light.

### (Appendix 8)

The head-up display device described in any one of appendixes 5 to 7, wherein the synthetic optical system further includes a phase sheet that rotates polarization directions of the second image light and the third image light by 90 degrees.

### (Appendix 9)

The head-up display device described in any one of appendixes 5 to 8, wherein the first display area, the second display area, and the third display area are different display areas of one image display device.

### (Appendix 10)

The head-up display device described in any one of appendixes 5 to 9, wherein

the first display area displays information on a speed of a vehicle and a status of the vehicle, and

the second display area and the third display area display information on attention attraction.

### (Appendix 11)

The head-up display device described in appendix 4 or 9, wherein the image display device is a liquid crystal display panel.

### (Appendix 12)

The head-up display device described in appendix 4 or 9, wherein the image display device is a projection display using a laser light source.

### (Appendix 13)

The head-up display device described in appendix 11 or 12, wherein an emission surface of image light of the image display device is orthogonal to an emission direction of the first image light.

### (Appendix 14)

The head-up display device described in appendix 11 or 12, wherein an emission surface of image light of the image display device is tilted relative to an emission direction of the first image light.

### (Appendix 15)

The head-up display device described in any one of appendixes 1 to 14, wherein the projection optical system includes a combiner.

### (Appendix (2))

### (Appendix 1)

A head-up display device including:

a synthetic optical system that superimposes first image light that travels through a first optical path and second image light that travels through a second optical path having an optical path length different from an optical path length of the first optical path on each other, the synthetic optical system emitting the first image light and the second image light superimposed on each other; and

a projection optical system that projects, as a virtual image, the first image light and the second image light that are superimposed on each other and emitted by the synthetic optical system.

### (Appendix 2)

The head-up display device described in appendix 1, wherein

the synthetic optical system includes a polarized light selection surface that selects reflection or transmission of light according to a polarization direction of the light,

the polarized light selection surface transmits the first image light by polarization,

the polarized light selection surface reflects the second image light by polarization, and

a region that transmits the first image light and a region that reflects the second image light overlap each other.

### (Appendix 3)

The head-up display device described in appendix 2, wherein

the synthetic optical system further includes a first reflection element that reflects the second image light while maintaining a polarization direction of the second image light, and

the second image light reflected by the first reflection element is reflected by the polarized light selection surface.

### (Appendix 4)

The head-up display device described in appendix 2 or 3, wherein

the polarized light selection surface includes a first polarized light selection surface and a second polarized light selection surface,

the first polarized light selection surface reflects the second image light by polarization, and

the second polarized light selection surface reflects third image light that travels through a third optical path having an optical path length different from an optical path length of the second optical path by polarization.

### (Appendix 5)

The head-up display device described in appendix 4, wherein at least one of the first polarized light selection surface and the second polarized light selection surface transmits the first image light by polarization.

### (Appendix 6)

The head-up display device described in appendix 4 or 5, wherein

the synthetic optical system further includes a second reflection element that reflects the third image light while maintaining a polarization direction of the third image light, and

the third image light reflected by the second reflection element is reflected by the second polarized light selection surface.

### (Appendix 7)

The head-up display device described in any one of appendixes 4 to 6, further including:

an image display module that emits the first image light, the second image light, and the third image light; and

a polarization rotation element that transmits light emitted from the image display module while rotating a polarization direction of the light emitted from the image display module, wherein

the first image light, the second image light, and the third image light are emitted from the one image display module, and

the polarization rotation element rotates polarization direction of the first image light or rotates polarization directions of the second image light and the third image light.

### (Appendix 8)

The head-up display device described in appendix 7, wherein

the image display module includes:

a first display region that emits the first image light,

a second display region that emits the second image light, and

a third display region that emits the third image light.

### (Appendix 9)

The head-up display device described in appendix 8, wherein a display surface of the image display module is disposed with a tilt relative to one or more of optical axes of the first through third image light.

### (Appendix 10)

The head-up display device described in appendix 9, wherein

the synthetic optical system further includes a first reflection element that reflects the second image light while maintaining the polarization direction of the second image light and a second reflection element that reflects the third image light while maintaining the polarization direction of the third image light, and

the tilt is adjusted by using a tilt of the first or second reflection element and a tilt of the polarized light selection surface.

### (Appendix 11)

The head-up display device described in any one of appendixes 1 to 3, further including:

an image display module that emits the first image light and the second image light; and

a polarization rotation element that transmits light emitted from the image display module while rotating a polarization direction of the light emitted from the image display module, wherein

the first image light and the second image light are emitted from the one image display module, and

the polarization rotation element rotates a polarization direction of one of the first image light and the second image light.

### (Appendix 12)

The head-up display device described in appendix 11, wherein

the image display module includes:

a first display region that emits the first image light, and

a second display region that emits the second image light.

### (Appendix 13)

The head-up display device described in appendix 11 or 12, wherein a display surface of the image display module is disposed with a tilt relative to one or more of optical axes of the first and second image light.

### (Appendix 14)

The head-up display described in any one of appendixes 7 to 13, wherein the image display module is a liquid crystal display panel.

### (Appendix 15)

The head-up display device described in any one of appendixes 7 to 13, wherein

the image display module scans a laser beam and displays an image on a screen, and

the screen maintains a polarization direction of the laser beam.

### (Appendix 16)

The head-up display device described in any one of appendixes 1 to 3 further including:

a first image display module that emits the first image light;

a second image display module that emits the second image light.

### (Appendix 17)

The head-up display device described in appendix 16, including a polarization rotation element that transmits light emitted from the first image display module or the second image display module while rotating a polarization direction of the light.

### (Appendix 18)

The head-up display device described in appendix 16 or 17, wherein

the first image display module includes a first display region that emits the first image light, and

the second image display module includes a second display region that emits the second image light.

### (Appendix 19)

The head-up display device described in appendix 18, wherein the first image display module is disposed with a tilt relative to an optical axis of the first image light or the second image display module is disposed with a tilt relative to an optical axis of the second image light.

### (Appendix 20)

The head-up display described in any one of appendixes 16 to 19, wherein the first and second image display modules are liquid crystal display panels.

### (Appendix 21)

The head-up display device of any one of appendixes 16 to 19, wherein the first and second image display modules scan laser beams and display images on screens, and

the screens maintain polarization directions of the laser beams.

### (Appendix 22)

The head-up display device described in any one of appendixes 4 to 6, further including:

a first image display module that emits the first image light;

a second image display module that emits the second image light; and

a third image display module that emits the third image light.

### (Appendix 23)

The head-up display device described in appendix 22, including a polarization rotation element that transmits light emitted from at least one of the first image display module, the second image display module, and the third image display module while rotating a polarization direction of the light.

### (Appendix 24)

The head-up display device described in appendix 22 or 23, wherein

the first image display module includes a first display region that emits the first image light,

the second image display module includes a second display region that emits the second image light, and

the third image display module includes a third display region that emits the third image light.

### (Appendix 25)

The head-up display device described in any one of appendixes 22 to 24, wherein one or more of a condition that a display surface of the first image display module is disposed with a tilt relative to an optical axis of the first image light, a condition that a display surface of the second image display module is disposed with a tilt relative to an optical axis of the second image light, and a condition that a display surface of the third image display module is disposed with a tilt relative to an optical axis of the third image light are satisfied.

### (Appendix 26)

The head-up display device described in any one of appendixes 22 to 25, wherein the first through third image display modules are liquid crystal display panels.

### (Appendix 27)

The head-up display device described in any one of appendixes 22 to 25, wherein

the first through third image display modules scan laser beams and display images on screens, and

the screens maintain polarization directions of the laser beams.

### DESCRIPTION OF REFERENCE CHARACTERS

liquid crystal display panel; 10a main area; 10b, 10c sub-area; 20, 20a, 20b synthetic optical system; 21 polarization beam splitter; 21b, 21c reflection surface; 22b, 22c, 24, 220b reflection mirror; 23 phase sheet; 30 projection optical system; 31 combiner; 40 eye box; 41 driver's eye; 60a, 60b, 60c, 61a, 61b, 61c, 62b, 63, 64 virtual image; 70a, 70b, 70c display distance; 100, 200, 300, 400 head-up display device; 100a, 100b, 100c image light; Oa, Ob, Oc optical axis.

1. A head-up display device comprising:
a synthetic optical system to superimpose first image light that travels through a first optical path and second image light that travels through a second optical path having an optical path length different from an optical path length of the first optical path on each other, and emit the first image light and the second image light superimposed on each other; and
a projection optical system to project, as a virtual image, the first image light and the second image light that are superimposed on each other and emitted by the synthetic optical system, wherein
the synthetic optical system includes a polarized light selection surface to select reflection or transmission of light according to a polarization direction of the light,
the polarized light selection surface transmits the first image light by polarization and reflects the second image light by polarization,
in the polarized light selection surface, a region that transmits the first image light and a region that reflects the second image light overlap each other,
the polarized light selection surface includes a first polarized light selection surface and a second polarized light selection surface,
the first polarized light selection surface reflects the second image light by polarization, and
the second polarized light selection surface reflects third image light that travels through a third optical path having an optical path length different from the optical path length of the second optical path by polarization.

2-3. (canceled)

4. The head-up display device according to claim 1, further comprising:
an image display module to emit the first image light, the second image light, and the third image light; and
a polarization rotation element to transmit light emitted from the image display module while rotating a polarization direction of the light emitted from the image display module, wherein
the first image light, the second image light, and the third image light are emitted from the one image display module, and
the polarization rotation element rotates a polarization direction of the first image light or rotates polarization directions of the second image light and the third image light.

5. The head-up display device according to claim 4, wherein
the image display module includes:
a first display region to emit the first image light;
a second display region to emit the second image light; and
a third display region to emit the third image light.

6. The head-up display device according to claim 5, wherein
the synthetic optical system further includes a first reflection element to reflect the second image light while maintaining the polarization direction of the second image light and a second reflection element to reflect the third image light while maintaining the polarization direction of the third image light,
a display surface of the image display module is disposed with a tilt relative to one or more of optical axes of the first through third image light, and
the tilt of the display surface is adjusted by using a tilt of the first or second reflection element and a tilt of the polarized light selection surface.

7. The head-up display device according to claim 1, further comprising:
a first image display module to emit the first image light;
a second image display module to emit the second image light; and
a third image display module to emit the third image light.

8. The head-up display device according to claim 7, wherein one or more of a condition that a display surface of the first image display module is disposed with a tilt relative to an optical axis of the first image light, a condition that a display surface of the second image display module is disposed with a tilt relative to an optical axis of the second image light, and a condition that a display surface of the third image display module is disposed with a tilt relative to an optical axis of the third image light are satisfied.

9. The head-up display device according to claim 7, wherein the first through third image display modules are liquid crystal display panels.

10-13. (canceled)

14. The head-up display device according to claim 8, wherein the first through third image display modules are liquid crystal display panels.
